(19) United States
(12) Patent Application Publication
(10) Pub. No.: US 2014/0165812 A1
(43) Pub. Date: Jun. 19, 2014

(54) SAW BLADE DISC AND TOOTH HOLDER ASSEMBLY

(71) Applicant: 9293-3720 QUEBEC INC., Quebec (CA)

(72) Inventor: Alain Jacques, Saint Rene (CA)

(73) Assignee: 9293-3720 QUÉBEC INC., Quebec, QC (CA)

(21) Appl. No.: 14/236,046

(22) PCT Filed: Jul. 27, 2012
(86) PCT No.: PCT/CA2012/050514

§ 371 Date: Jan. 29, 2014

Related U.S. Application Data
(60) Provisional application No. 61/512,623, filed on Jul. 28, 2011.

(51) Int. Cl. B23D 61/02; B26D 7/26; B23D 61/06

(52) U.S. Cl. CPC B23D 61/025; B23D 61/06; B26D 7/2621
USPC 83/835; 83/698.41; 76/112

(57) ABSTRACT

A saw-blade comprises a disc and a plurality of tooth holders. The saw blade disc has a plurality of receiving stations with at least one recess with an indentation extending tangentially from a radially inner leading edge portion thereof. Each one of the tooth holders has a protrusion extending tangentially from a radially inner leading edge portion thereof. The tooth holders are engageable in the receiving stations of the saw blade disc with the protrusions of the tooth holders being inserted in the indentation of the receiving stations.

### CROSS-REFERENCE TO RELATED APPLICATIONS

This application claims priority under 35USC§119(e) of U.S. provisional patent application 61/512,623 filed on Jul. 28, 2011, the specification of which is hereby incorporated by reference.

### BACKGROUND

The use of circular saw blades for cutting hard materials such as calcined carbon bodies is known per se. Such circular saw blades were known to have cutting teeth removably mounted to a plurality of circumferentially interspaced positions on a saw blade disc via corresponding tooth holders.

Although such former saw blades were satisfactory to a certain degree, there remained room for improvement. In particular, cutting hard materials imparts high levels of stress on the cutting teeth and holders, which was known to affect the durability. Furthermore, fastening of the tooth holders to the disc remained to be improved as limitations in terms of ruggedness of the assembly were known to cause premature wear and precision limitations, following phenomena such as vibrations.

### SUMMARY

It was found that the saw blade disc/tooth holder assembly can be improved in the following independent ways. Firstly, improvement can be provided by using a male-female engagement between the saw blade disc and the tooth holder. More particularly, the tooth holder can be made with two interspaced leg members which overlap the disc on both sides thereof, with the disc firmly trapped therebetween. Secondly, the receiving stations of the disc where the corresponding tooth holders are inserted and mounted can be formed of two symmetrical recesses, each penetrating inwardly into the body of the disc to a web, on a corresponding side, and into which the legs of the tooth holder can be snugly nested. Thirdly, the correspondingly shaped recesses and legs can be formed with a tangentially protruding and mating indentation and protrusion at a leading edge thereof, somewhat spaced radially-inward from the periphery of the disc, and the trailing edge can be of an arcuate shape, in a manner that the tooth holder is prevented from being engaged with the corresponding receiving portion in a straight radial movement, but rather engaged with a circular engaging movement, beginning with inserting the protrusion of the tooth holder in the corresponding recesses and continuing by inserting the trailing edge snugly into place.

In accordance with one aspect, there is provided a saw-blade comprising: a disc having a plurality of receiving stations circumferentially interspaced along an outer periphery thereof, each one of the receiving stations having two opposite recesses penetrating inwardly from a corresponding face of the disc to a web; and a plurality of tooth holders having two spaced-apart legs, each one of the tooth holders being received by a corresponding one of the receiving stations with the two legs mating with the web and being received in a corresponding one of the recesses, wherein the corresponding recesses and legs are formed with complementary indentation and protrusion extending at a leading edge thereof, the protrusion and the indentation being spaced-apart from the outer periphery in a manner to require a rotation movement to remove the tooth holders.

In accordance with another aspect, there is provided a saw blade disc comprising a plurality of receiving stations circumferentially interspaced along an outer periphery thereof, each one of the receiving stations having at least one recess extending radially inward from the outer periphery with an indentation extending tangentially from a leading edge thereof, the indentation being spaced-apart from the outer periphery in a manner to require a rotation movement to engage or disengage legs of a tooth holder being shaped in accordance with the shape of the recesses.

In accordance with another aspect, there is provided a method of assembling a tooth holder comprising two legs having a protrusion extending tangentially from a radially inner leading edge portion thereof, to a receiving station of a saw blade disc having a web mating with a spacing between the two legs, the web being formed between two recesses shaped to snugly receive the legs, the method comprising: engaging the web of the disc with the spacing formed between the protrusions of the legs, and effecting a rotation movement to engage the web deeper within the spacing until the legs are snugly received in the recesses.

In accordance with another aspect, there is provided a saw-blade comprising: a disc having a plurality of receiving stations circumferentially interspaced along an outer periphery thereof, each one of the receiving stations having at least one recess extending radially inwardly in the disc, the at least one recess having an indentation defined at a leading edge thereof; and a plurality of tooth holders having a lower section, each one of the tooth holders being received by a corresponding one of the receiving stations with the lower section received in a corresponding one of the recesses, wherein each one of the lower sections includes a protrusion extending at a leading edge thereof and being complementary to the indentation defined at the leading edge of the corresponding one of the recesses, the protrusion and the indentation being spaced-apart from the outer periphery in a manner to require a rotation movement to remove the tooth holders from the receiving stations.

In some implementations, each one of the receiving stations comprises two opposite recesses, each one of the recesses penetrating inwardly from a corresponding face of the disc to a web and the lower section of the tooth holders comprises two legs mating with the web of the receiving stations, with each one of the legs being snugly received in a corresponding one of the recesses. The legs can comprise the protrusions of the tooth holder.

In some implementations, the corresponding recesses and legs are symmetrical along a central plane of the disc. In some implementations, the protrusion is shaped in the form of a bulge, the indentation has a complementary shape and the protrusion and the indentation protrude tangentially. The indentation can be provided at a radially inward end of the leading edge. The tooth holders comprise the protrusions and the recesses of the receiving stations comprise the indentations. In some implementations, each one of the corresponding recesses and legs has a trailing edge of an arcuate shape configured for the trailing edge of the recesses to guide the trailing edge of the legs as the protrusion of the legs is moved into the indentation of the recesses.

In some implementations, each one of the tooth holders and the recesses has a trailing edge, spaced-apart from the leading edge, and the leading edge and the trailing edge are portions of arcs of two concentric circles having a center. The center of the concentric circles can be located outwardly of the disc. The indentations of the recesses and the protrusions of the tooth holders can extend forwardly of their corresponding leading edge.

In some implementations, at least a section of a mating edge of the legs and recesses slopes inwardly in a manner that as the tooth holder is pressed against the mating edges of the recesses the mating edges of the recesses press the legs against the web.

In some implementations, each one of the legs and the recesses has a trailing edge, spaced-apart from the leading edge, and a lower edge and, at least one of the trailing edge, the leading edge, and the lower edge is a bevelled edge.

In some implementations, each one of the tooth holders and the recesses comprises an inner side and an outer side with the inner side being wider than the outer side.

In some implementations, the lower portion and/or the legs are snugly received in the corresponding one of the recesses.

In some implementations, the disc is a circular and substantially planar member rotatably securable on a spindle in a machining unit or a processing machine.

In accordance with another aspect, there is provided a tooth holder comprising a body with a lower section having a protrusion extending forwardly from the lower section.

The indentations can be provided at a radially-inward end of the leading edges.

In some implementations, the required rotation movement is opposite to a moment of force to be exerted upon the tooth holder during use.

Many further features and combinations thereof concerning the present improvements will appear to those skilled in the art following a reading of the instant disclosure.

For the sake of simplicity, the expressions tangential and radial can be used in this specification in relation to a tooth holder in reference to its engaged position irrespective of whether it is currently engaged on the disc or not. The expressions “forward” and “leading” refer to the direction where the tooth holder is intended to face during use, whereas lower refers to radially inward when assembled to the disc.

### DESCRIPTION OF THE FIGURES

In the figures,

FIG. 1 is a side elevation view of a disc in accordance with an embodiment;

FIG. 2 includes FIGS. 2A and 2B showing a portion of the disc of FIG. 1 with FIG. 2A being a side elevation view, enlarged, and FIG. 2B being a cross-sectional view, enlarged, taken along section lines 2B-2B of FIG. 2A;

FIG. 3 includes FIGS. 3A and 3B showing a tooth holder with FIG. 3A being a side elevation view, enlarged, and FIG. 3B being a cross-sectional view, enlarged, taken along section lines 3B-3B of FIG. 3A;

FIG. 4 includes FIGS. 4A to 4C, FIGS. 4A to 4C being side elevation views of the tooth holder shown in FIG. 3 being inserted in a receiving station of the disc shown in FIG. 2 with and, more particularly, Figs. FIGS. 4A to 4C show, in sequence, the rotation movement required to engage the tooth holder with the receiving station of the disc; and

FIG. 5 includes 5A and 5B showing the tooth holder engaged to the receiving station, for use with FIG. 5A being a side elevation view and FIG. 5B being a cross-sectional view taken along section lines 5B-5B of FIG. 5A.

It will be noted that throughout the appended drawings, like features are identified by like reference numerals.

### DETAILED DESCRIPTION

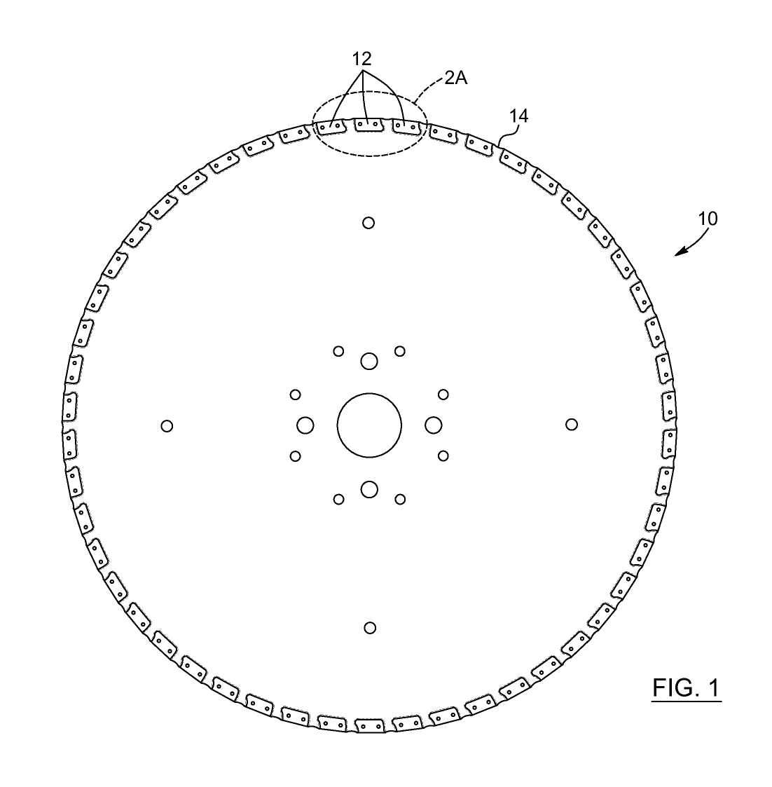

FIG. 1 shows an example of a saw blade disc 10 for receiving tooth holders 30. The saw blade disc 10 is a circular and substantially planar member designed to be rotatably mounted on a spindle in a machining unit or processing machine.

The saw blade disc 10 has a plurality of tooth holder receiving stations 12 circumferentially interspaced along an outer periphery 14 of the disc 10. The detailed configuration of the disc 10 which is illustrated is provided solely for the purpose of illustration. The body of the disc 10 can greatly depart from the one illustrated in alternative embodiments.

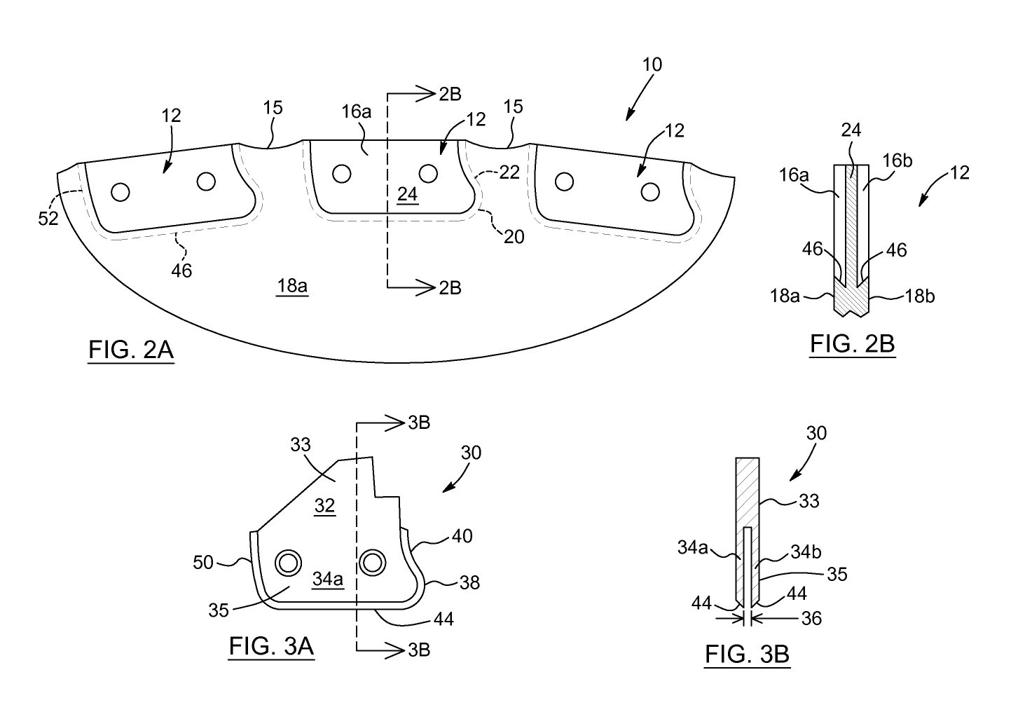

In an embodiment, the tooth holder receiving stations 12 are substantially equally spaced-apart along the outer periphery 14 of the disc 10, and gullet spaces 15 (FIG. 2A) are provided between adjacent tooth holder receiving stations 12.

FIG. 2A shows the portion of the disc 10 correspondingly identified on FIG. 1, enlarged, showing three identical and adjacent receiving stations 12. As seen when also referring to the cross-section view shown in FIG. 2B, each receiving station 12 is formed of a pair of recesses 16a, 16b extending radially-inward from the outer periphery 14 of the disc 10, on a corresponding face 18a, 18b thereof, and spaced-apart from one another by a web 24 extending inbetween. The recesses 16a, 16b are cavities defined in the faces 18a, 18b of the disc 10. In the embodiment shown, in addition to a wall defined by the web 24, the recesses 16a, 16b are defined by a lower edge 46 and two spaced-apart side edges 22, 52, namely a leading edge 22 and a trailing edge 52, with round corners. One skilled in the art will appreciate that the shape of the recesses 16a, 16b can vary from the embodiment shown. The end of the recesses 16a, 16b corresponding to the outer periphery 14 of the disc 10 is open. The recesses 16a, 16b further includes an indentation 20 extending tangentially from a leading edge 22 thereof, and being radially spaced from the outer periphery 14. In this example, the indentation 20 is a cavity in the shape of a substantially rounded depression, but the shape thereof can differ in alternative embodiments. The web 24 is present between the recesses 16a, 16b. It will be noted that the recesses 16a, 16b can be machined in the disc, for example.

In the non-limitative embodiment shown, except for the lower edge 46 of the recesses 16a, 16b, the outline of the recesses 16a, 16b has a substantially curved shape to facilitate the insertion of a tooth holder 30, as it will be described in more details below.

As shown in FIG. 2A, in this particular embodiment, the area of the recesses 16a, 16b is more important adjacent to the web 24 than adjacent to the faces 18a, 18b of the disc 10. In other words, the leading, lower, and trailing edges 22, 46, 52 are bevelled edges, i.e. they are not perpendicular to the faces 18a, 18b of the disc 10, with the inner side being longer than the outer side. Thus, the inner side of the recesses 16a, 16b, i.e. the one juxtaposed to the web 24, is wider than their outer side, i.e. the one corresponding to a respective one of the faces 18a, 18b of the disc 10.

FIG. 3A shows an example of a tooth holder 30 which is matingly shaped to engage with the receiving stations 12. The tooth holder 30 has a body 32 with an upper section 33 and two depending legs 34a, 34b interspaced from one another by a spacing distance 36, which substantially corresponds to the thickness of the web 24. The shape of the legs 34a, 34b corresponds to the shape of the recesses 16a, 16b in a manner that once the tooth holder 30 is engaged in the receiving station 12, the spaced-apart legs 34a, 34b are snugly received in the recesses 16a, 16b. Henceforth, the legs 34a, 34b also have a protrusion 38, and the protrusion 38 can be said to be at a lower, or radially-inner, portion of the tooth holder 30, at the leading edge 40 thereof, and can thus be said to extend in a forward direction, with respect to the direction the tooth holder is intended to face during use. The protrusion 38 is in the shape of a substantially rounded bulge and the indentation 20 has a complementary shape. As the recesses 16a, 16b, each one of the legs 34a, 34b of the tooth holder 30 has a leading edge 40, a trailing edge 50, spaced-apart from the leading edge 40, and a lower edge 44. When the tooth holder 30 is snugly received in the recesses 16a, 16b, the corresponding leading edges 22, 40 of the recesses 16a, 16b and the tooth holder 30 are juxtaposed. Similarly, the corresponding trailing edges 50, 52 and lower edges 44, 46 of the tooth holder and the recesses 16a, 16b are also juxtaposed. Furthermore, the protrusions 38 of the tooth holder 30 are received in the corresponding indentations 20 of the recesses 16a, 16b, as described in more detail below. Thus, the protrusions 38 and the indentations 20 have substantially the same shape.

In this particular example, the lower mating edges 44, 46 of the recesses 16a, 16b and the legs 34a, 34b are formed of a matingly sloping shape, with the inner side being longer than the outer side. This can contribute to maintain the legs 34a, 34b pressed against the web 24 when forced against by the tooth holder 30. Similarly, the leading and trailing edges 22, 52, 40, 50 of the recesses 16a, 16b and the tooth holder 30 are also bevelled edges with the inner side being longer than the outer side. In alternative embodiments, this feature can be omitted entirely, or be present along only a section of the corresponding edges 22, 40, 44, 46, 50, 52, for instance. Thus, the inner sides of the recesses 16a, 16b and the legs 34a, 34b, i.e. the ones juxtaposed to the web 24, are wider than their outer sides, i.e. the ones corresponding or substantially aligned with a respective one of the faces 18a, 18b of the disc 10.

Further it will be noted that in this example, the width of the tooth holder 30 corresponds to the width of the disc 10, in a manner that the legs 34a, 34b become housed flush within the recesses 16a, 16b when engaged. This is also optional and the legs 34a, 34b can protrude outwardly from the disc 10 in an alternative embodiment. In another alternative embodiment, the tooth holder 30 can be narrower than the disc 10, at least in the lower section 35.

The leading edges 22, 40 and the trailing edges 52, 50 of the recesses 16a, 16b and the tooth holder 30 have an arc shape. In a non-limitative embodiment, the arc shape of the leading edges 22, 40 and the trailing edges 52, 50 are portions of an arc of two concentric circles, with the inner circle defining the leading edges 22, 40 having the smallest diameter. The center of the two imaginary circles corresponding to the leading edges 22, 40 and the trailing edges 52, 50 is located at least above the outer periphery 14 of the disc 10, i.e. outside of the disc 10.

In an alternative embodiment (not shown), the lower section 35 of the tooth holder 30 can be a single piece, i.e. it includes a single leg extending continuously from the upper section 33 of the body 32. In this alternative embodiment, the disc 10 includes receiving stations 12 designed to receive the tooth holders 30 and each one of the receiving stations 12 is a single and continuous recess, free of web 24.

The indentations 20 of the recesses 16a, 16b and the protrusions 38 of the tooth holder 30 extend forwardly of its corresponding leading edge 22, 40. In other words, a radius defined between the tip of the indentations 20 and the protrusions 38 and the center of disc 10 is located forwardly, with respect to the direction the tooth holder 30 is intended to face during use, of a radius defined between the junction of the leading edge 22, 40 and the outer periphery 14 of the disc 10. This configuration prevents rearward flipping of the tooth holder 30 during use.

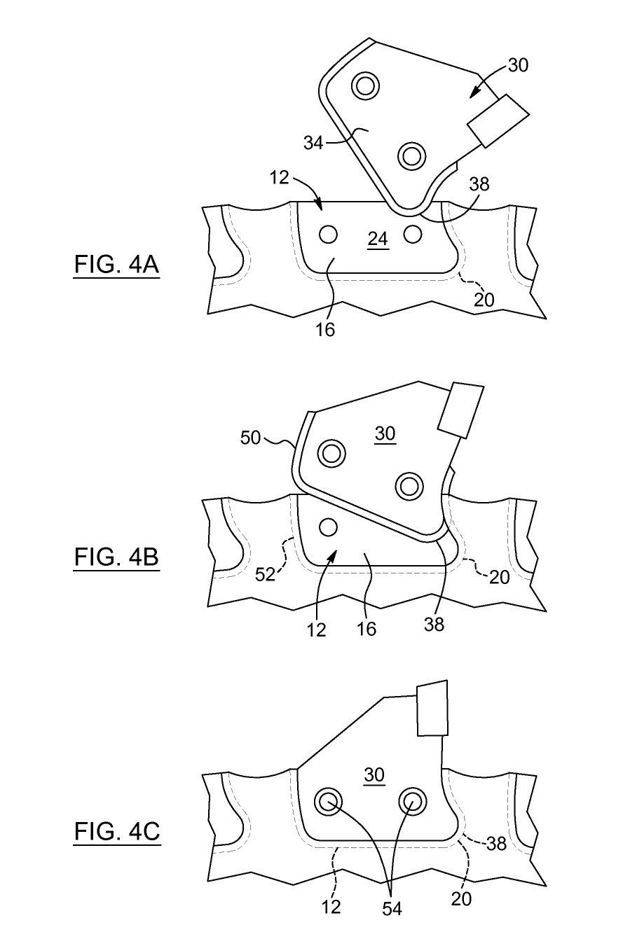

FIGS. 4A to 4C show a sequence of rotation movements which allow to engage, or disengage, a tooth holder 30 with a receiving station 12. As shown in FIG. 4A, the web 24 can be engaged between the legs 34 beginning by the protrusion 38, then, FIG. 4B shows that the protrusion 38 can be guided to the indentation 20 of the recesses 16 as the tooth holder 30 is both rotated counter-clockwise toward a radial inner direction until the protrusion 38 of the legs is engaged with the indentation 20 of the recesses 16 as shown in FIG. 4C. One skilled in the art will appreciate that the tooth holder 30 is rotated clockwise if observed from the opposite side of the disc 10. Further, it can be seen in this sequence that the trailing edges 50, 52 of the legs and recesses 16 have an arcuate shape which acts in a manner that the trailing edge 52 of the recesses 16 guides the trailing edge 50 of the legs 34 during the rotation movement until the legs 34 are snugly received in the recesses 16. The tooth holder 30 can then be fastened into this position by one or more fasteners 54, such as screws, rivets, etc. Alternatively, these parts may be joined by means of other available fixing techniques such as welding, gluing, etc.

To engage or disengage the tooth holder 30 in one of the receiving stations 12, the tooth holder 30 is rotated and travels along an arc of an imaginary circle, which has a center.

In an embodiment, the center of the imaginary circle is located at least above the outer periphery 14 of the disc 10, i.e. outside of the disc 10.

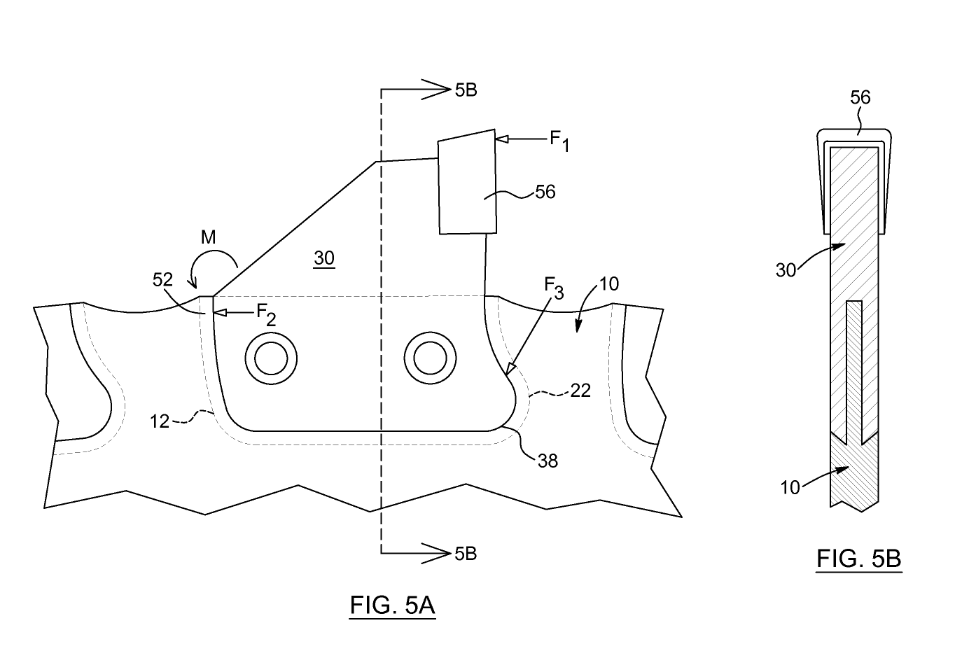

Turning to FIG. 5A, it will be understood that this configuration can provide an elevated degree of ruggedness during use. For instance, during use, a force F₁ is exerted upon the tooth 56 by a workpiece (not shown) as the disc 10 is rotated. This force F₁ is transferred to the tooth holder 30 and a force F₂ is exerted by the tooth holder 30 onto the trailing edge 52 of the receiving station 12. However, because the force F₂ exerted by the tooth holder 30 is not aligned with the force F₁ exerted on the tooth 56 by the workpiece, a moment of force M results which tends to rotate the tooth holder 30 in its receiving station 12 or socket. It can be understood here that the presence of the protrusion 38 at the illustrated location allows the leading edge 22 of the receiving station 12 to exert a counteracting force F₃ onto the tooth holder 30 which counteracts the moment of force M and thus reduces the occurrence of play or vibration in the assembly, which can, in turn, improve the life expectancy of the tooth 56.

In an alternative embodiment (not shown), one skilled in the art will appreciate that the lower edges 44, 46 of the tooth holder 30 and the recesses 16a, 16b can extend upwardly or downwardly, i.e. the leading edges 22, 40 including the indentation 20 and the protrusion 38 can be either longer or shorter than the trailing edges 50, 52.

Moreover, although the embodiments of the disc, tooth holder and corresponding parts thereof consist of certain geometrical configurations as explained and illustrated herein, not all of these components and geometries are essential to the invention and thus should not be taken in their restrictive sense. It is to be understood, as also apparent to a person skilled in the art, that other suitable components and cooperation thereinbetween, as well as other suitable geometrical configurations, may be used for the disc and tooth holder according to the present invention, as it will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention. The scope of the invention is therefore intended to be limited solely by the scope of the appended claims.

What is claimed is:

1. A saw-blade comprising:
a disc having a plurality of receiving stations circumferentially interspaced along an outer periphery thereof, each one of the receiving stations having two opposite recesses penetrating inwardly from a corresponding face of the disc to a web; and
a plurality of tooth holders having two spaced-apart legs, each one of the tooth holders being received by a corresponding one of the receiving stations with the two legs mating with the web and being received in a corresponding one of the recesses, wherein the corresponding recesses and legs are formed with complementary indentation and protrusion extending at a leading edge thereof, the protrusion and the indentation being spaced-apart from the outer periphery in a manner to require a rotation movement to remove the tooth holders.

2. The saw-blade of claim 1, wherein the corresponding recesses and legs are symmetrical along a central plane of the disc.

3. The saw-blade of one of claims 1 and 2, wherein the protrusion is shaped in the form of a bulge and the indentation has a complementary shape.

4. The saw-blade of any one of claims 1 to 3, wherein the protrusion and the indentation protrude tangentially.

5. The saw-blade of any one of claims 1 to 4, wherein the indentation is provided at a radially inward end of the leading edge.

6. The saw-blade of any one of claims 1 to 5, wherein the tooth holders comprise the protrusions and the recesses of the receiving stations comprise the indentations.

7. The saw-blade of claim 6, wherein each one of the corresponding recesses and legs has a trailing edge of an arcuate shape configured for the trailing edge of the recesses to guide the trailing edge of the legs as the protrusion of the legs is moved into the indentation of the recesses.

8. The saw-blade of any one of claims 1 to 7, wherein each one of the tooth holders and the recesses has a trailing edge, spaced-apart from the leading edge, and the leading edge and the trailing edge are portions of arcs of two concentric circles having a center.

9. The saw-blade of claim 8, wherein the center of the concentric circles is located outwardly of the disc.

10. The saw-blade of any one of claims 1 to 9, wherein the indentations of the recesses and the protrusions of the tooth holders extend forwardly of their corresponding leading edge.

11. The saw-blade of any one of claims 1 to 10, wherein at least a section of a mating edge of the legs and recesses slopes inwardly in a manner that as the tooth holder is pressed against the mating edges of the recesses the mating edges of the recesses press the legs against the web.

12. The saw-blade of any one of claims 1 to 11, wherein each one of the legs and the recesses has a trailing edge, spaced-apart from the leading edge, and a lower edge and, at least one of the trailing edge, the leading edge, and the lower edge is a bevelled edge.

13. The saw-blade of any one of claims 1 to 11, wherein each one of the tooth holders and the recesses comprises an inner side and an outer side with the inner side being wider than the outer side.

14. The saw-blade of any one of claims 1 to 13, wherein the legs are snugly received in the corresponding one of the recesses.

15. The saw-blade of any one of claims 1 to 13, wherein the disc is a circular and substantially planar member rotatably securable on a spindle in a machining unit or a processing machine.

16. A tooth holder comprising a body with a lower section having a protrusion extending forwardly from the lower section.

17. The tooth holder of claim 16, wherein the protrusion is shaped in the form of a bulge extending forwardly of a leading edge of the body.

18. The tooth holder of claim 16, wherein the lower section comprises two depending legs interspaced from one another by a spacing and being correspondingly shaped, the legs having a leading edge and a trailing edge.

19. The tooth holder of claim 18, wherein a periphery of the legs slopes inwardly.

20. The tooth holder of one of claims 18 and 19, wherein the trailing edge of the legs is of an arcuate shape.

21. The tooth holder of claim 16, wherein the body comprises a leading edge and a trailing edge, spaced-apart from the leading edge, the leading edge and the trailing edge are portions of arcs of two concentric circles having a center.

22. A saw blade disc comprising a plurality of receiving stations circumferentially interspaced along an outer periphery thereof, each one of the receiving stations having at least one recess extending radially inward from the outer periphery with an indentation extending tangentially from a leading edge thereof, the indentation being spaced-apart from the outer periphery in a manner to require a rotation movement to engage or disengage legs of a tooth holder being shaped in accordance with the shape of the recesses.

23. The saw blade disc of claim 22, wherein the indentations are provided at a radially-inward end of the leading edges.

24. The saw blade disc of one of claims 22 to 23, wherein each one of the recesses has a trailing edge, spaced-apart from the leading edge, and the leading edge and the trailing edge are portions of arcs of two concentric circles having a center.

25. The saw blade disc of claim 24, wherein the center of the concentric circles is located outwardly of the disc.

26. The saw blade disc of any one of claims 22 to 25, wherein the indentations of the recesses extend forwardly of their corresponding leading edge.

27. The saw blade disc of any one of claims 22 to 26, wherein the at least one recess comprises two opposite recesses, each one of the recesses penetrating transversally inward from a corresponding face of the disc to a web therebetween.

28. The saw blade disc of claim 27, wherein the recesses are symmetrical along a central plane of the disc.

29. The saw-blade disc of one of claims 27 and 28, wherein each one of the legs has a trailing edge, spaced-apart from the leading edge, and a lower edge and, at least one of the trailing edge, the leading edge, and the lower edge is a bevelled edge.

30. The saw blade disc of any one of claims 22 to 29, wherein the disc is a circular and substantially planar member rotatably securable on a spindle in a machining unit or a processing machine.

31. A method of assembling a tooth holder comprising two legs having a protrusion extending tangentially from a radially inner leading edge portion thereof, to a receiving station of a saw blade disc having a web mating with a spacing between the two legs, the web being formed between two recesses shaped to snugly receive the legs, the method comprising:
engaging the web of the disc with the spacing formed between the protrusions of the legs, and
effecting a rotation movement to engage the web deeper within the spacing until the legs are snugly received in the recesses.

32. A saw-blade comprising:
a disc having a plurality of receiving stations circumferentially interspaced along an outer periphery thereof, each one of the receiving stations having at least one recess extending radially inwardly in the disc, the at least one recess having an indentation defined at a leading edge thereof; and
a plurality of tooth holders having a lower section, each one of the tooth holders being received by a corresponding one of the receiving stations with the lower section received in a corresponding one of the recesses, wherein each one of the lower sections includes a protrusion extending at a leading edge thereof and being complementary to the indentation defined at the leading edge of the corresponding one of the recesses, the protrusion and the indentation being spaced-apart from the outer periphery in a manner to require a rotation movement to remove the tooth holders from the receiving stations.

33. The saw-blade of claim 32, wherein the protrusion is shaped in the form of a bulge and the indentation has a complementary shape.

34. The saw-blade of one of claims 32 and 33, wherein the protrusion and the indentation are provided at a radially inward end of the leading edge.

35. The saw-blade of any one of claims 32 to 34, wherein the recesses and the lower section of the tooth holders have a trailing edge of an arcuate shape configured for the trailing edge of the recesses to guide the trailing edge of the tooth holders as the protrusion of the tooth holders is moved into the indentation of the recesses.

36. The saw-blade of any one of claims 32 to 35, wherein the protrusions and the indentations protrude tangentially.

37. The saw-blade of any one of claims 32 to 36, wherein the indentation is spaced radially-inward from the outer periphery of the disc.

38. The saw-blade of any one of claims 32 to 37, wherein each one of the tooth holders and the recesses has a trailing edge, spaced-apart from the leading edge, and the leading edge and the trailing edge are portions of arcs of two concentric circles having a center.

39. The saw-blade of claim 38, wherein the center of the concentric circles is located outwardly of the disc.

40. The saw-blade of any one of claims 32 to 39, wherein the indentations of the recesses and the protrusions of the tooth holders extend forwardly of their corresponding leading edge.

41. The saw-blade of any one of claims 32 to 40, wherein the required rotation movement is opposite to a moment of force to be exerted upon the tooth holder during use.

42. The saw-blade of any one of claims 32 to 41, wherein the lower section is snugly received in a corresponding one of the recesses.

43. The saw-blade of any one of claims 32 to 41, wherein each one of the receiving stations comprises two opposite recesses, each one of the recesses penetrating inwardly from a corresponding face of the disc to a web and the lower section of the tooth holders comprises two legs mating with the web of the receiving stations, with each one of the legs being snugly received in a corresponding one of the recesses.

44. The saw-blade as claimed in claim 43, wherein the legs comprise the protrusions of the tooth holder.

45. The saw-blade of one of claims 43 and 44, wherein the corresponding recesses and legs are symmetrical along a central plane of the disc.

46. The saw-blade of any one of claims 43 to 45, wherein each one of the legs and the recesses has a trailing edge, spaced-apart from the leading edge, and a lower edge and, at least one of the trailing edge, the leading edge, and the lower edge is a bevelled edge.

47. The saw-blade of any one of claims 32 to 46, wherein the disc is a circular and substantially planar member rotatably securable on a spindle in a machining unit or a processing machine.
